(19) United States
(12) Patent Application Publication
(10) Pub. No.: US 2026/0167798 A1
(43) Pub. Date: Jun. 18, 2026

(54) POLYMER COMPOSITION

(71) Applicant: Jiaxing Fuying Composite Materials Co., Ltd., Jiaxing City (CN)

(72) Inventors: Chao Wang, Jiaxing City (CN); Yincheng Li, Jiaxing City (CN); Weimin Ye, Jiaxing City (CN); Zhenzhen Chen, Jiaxing City (CN)

(21) Appl. No.: 18/709,743

(22) PCT Filed: Apr. 18, 2024
(86) PCT No.: PCT/CN2024/088562

§ 371 Date: May 13, 2024

(30) Foreign Application Priority Data
Mar. 14, 2024 (CN) 2024102946435

(51) Int. Cl. C08K 5/11; C08K 5/00; C08K 5/12

(52) U.S. Cl. CPC C08K 5/11; C08K 5/0016; C08K 5/12; C08L 2666/02

(57) ABSTRACT

The present disclosure relates to a polymer composition, and belongs to the technical field of PVB plasticizers. The polymer composition includes PVB and plasticizer, wherein the plasticizer has a structure as shown in a formula 1a or 1b; 1a R1-(C₆H₄)—(—OCH₂CH₂—)ₙ—OH; 1b R2-(-OCH₂CH₂—)ₙ—OH; wherein, n is an integer ranging from 2 to 30; R1 is C6-C16 aliphatic hydrocarbyl; and R2 is saturated or aliphatic hydrocarbyl having 12 to 20 carbon atoms in a linear carbon chain form. An elongation at break is a sign of softness, and it has been discovered through experimental study in the present disclosure that a substance with the structure as shown in the formula 1a or 1d has significant advantages relative to 3G8 when used as a PVB plasticizer, which is mainly reflected in the significant increase in the elongation at break.

### CROSS REFERENCE TO RELATED APPLICATIONS

This is a 371 national stage patent application of PCT International Application No. PCT/CN2024/088562, filed Apr. 18, 2024, which claims priority to Chinese Patent Application No. CN 2024102946435, filed Mar. 14, 2024; the disclosures of which are incorporated herein by reference in their entireties.

### TECHNICAL FIELD

The present disclosure relates to a polymer composition, and belongs to the technical field of polyvinyl butyral (PVB) plasticizers.

### BACKGROUND

Safety glass, also known as laminated glass, is combined glass formed by bonding two or more layers of glass through PVB films, which can absorb impact energy and reduce the splash of broken sheets, and is thus widely used in automobiles and buildings.

With the progress of society, people's requirements for the laminated glass are becoming higher and higher. It is mainly reflected in the improvement in the performance requirements of the PVB films. The PVB rubber sheets are required to have the advantages of 1. good bonding force for glass; 2. good tensile strength and elongation at break; 3. good light transmittance; and 4. good sound insulation.

Although PVB is still far ahead compared to other polymer materials after comprehensively considering the above four aspects, it still cannot meet the increasing requirements of people, especially in elongation at break and sound insulation.

For example, a Chinese invention patent application (application No.: CN201910115373.6) has disclosed a sound insulation polyvinyl butyral film. The present disclosure is proposed in order to provide a PVB film with a better sound insulation effect. A tetrapod-like zinc oxide whisker is used as a sound insulation aid, triethylene glycol di-2-ethylhexoate and other substances are used as a plasticizer, ethanol and other substances are used as an organic solvent, and all the substances are poured into a PET mold after being fully mixed, and then dried in an oven, so as to prepare the PVB film with the sound insulation effect.

A Chinese invention patent application (application No.: CN202310805999.6) has disclosed composite PVB resin powder, including 80-120 parts of PVB resin, 10-20 parts of plasticizer, 0.2-1 part of modified tetrapod-like zinc oxide whisker, 0.1-0.3 part of antioxidant, 0.1-0.3 part of ultraviolet absorbent and 0.1-0.2 part of surface tension regulator. The plasticizer is one or a combination of two or more of diisooctyl phthalate, dialkyl sebacate, and dialkyl adipate. In this patent, the tetrapod-like zinc oxide whisker is also used as the sound insulation aid, furthermore, the tetrapod-like zinc oxide whisker is further subjected to graft modification, making its surface transformed from being hydrophilic and oleophobic to oleophilic and hydrophobic, and therefore improving the dispersibility of the tetrapod-like zinc oxide whisker in PVB.

However, PVB films in the prior art still have the problems such as not being soft enough (not high in elongation at break).

### SUMMARY

In order to solve the above technical problems, the present disclosure provides a polymer composition. An elongation at break of a PVB film prepared from the polymer composition provided by the present disclosure is significantly increased.

The present disclosure provides the following technical solution for solving the above technical problems:

A polymer composition, includes PVB resin and an amphiphilic oligomer plasticizer, wherein the amphiphilic oligomer plasticizer has a structure as shown in a formula 1a or 1b;

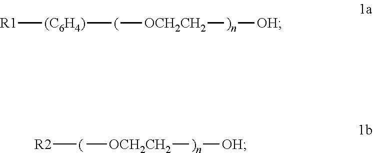

wherein, n is an integer ranging from 2 to 30; R1 is a saturated or unsaturated aliphatic hydrocarbon group having 6 to 16 carbon atoms in a linear carbon chain or branched chain form; and R2 is a saturated or unsaturated aliphatic hydrocarbon group having 12 to 20 carbon atoms in a linear carbon chain form.

As a preference of the above technical solution, n is an integer ranging from 10 to 20.

The principle of plasticizing is to use a micromolecular substance to dilute resin macromolecules to reduce the bulk density of the resin macromolecules, so as to show the performance of softening products from the macroscopical view. Amore professional statement is that when a plasticizer and resin melt together, small molecules of the plasticizer will be intercalated between polymer molecular chains, increasing distances therebetween, resulting in reducing the entanglement between the polymer molecular chains and increasing the mobility of the polymer molecular chains, so that the resin can undergo glass transition at a lower temperature, thereby increasing plasticity. Of course, the premise is that this micromolecular substance has good compatibility with the resin macromolecules. Polyethylene wax may be used as a plasticizer of polyethylene based on the above principle.

Triethylene glycol di-2-ethylhexoate, as a special PVB plasticizer at present, has the same plasticizing performance as dioctyl phthalate (DOP), but has lower biotoxicity. A synthesis process of this substance includes two steps: step 1, making monomolecular triethylene glycol react with monomolecular isooctanoic acid to generate triethylene glycol uni-2-ethylhexoate; and step 2, making the monomolecular triethylene glycol uni-2-ethylhexoate react with the monomolecular isooctanoic acid to generate the triethylene glycol di-2-ethylhexoate; Therefore, both terminals of this substance are of an isooctanoate structure, with very low polarity/high lipophilicity.

In the prior art, plasticizers are generally considered as non-polar, such as a PVC plasticizer, namely dioctyl phthalate (DOP), and a PVB plasticizer, namely triethylene glycol di-2-ethylhexoate (3G8).

However, an inventor considers that 3G8 is actually not very suitable as the PVB plasticizer.

This is due to the specificity of the PVB resin. The PVB resin is different from PVC resin, although the C—Cl bond has polar properties in the PVC resin, the high molecular symmetry results in a low overall polarity that does not allow it to be dissolved in water, ethanol or other polar solvents. While there are many polar groups such as —OH, a small quantity of polar groups such as —OCOCH₃ and a large quantity of non-polar groups such as —CH₂CH₂CH₃ in the PVB resin, and the PVB resin has very low molecular crystallinity, so that PVB has certain polarity changing with a specific composition of PVB, especially the content of —OH. Therefore, during the selection of an appropriate PVB plasticizer, we cannot be trapped in past thinking patterns.

The inventor considers that the research and development thought of the triethylene glycol di-2-ethylhexoate in the prior art can be understood as double-terminal graft modification for improving fat solubility of triethylene glycol. That is, hydrocarbon groups at both terminals of triethylene glycol are transformed into isooctanoate, thereby transforming polar triethylene glycol into non-polar triethylene glycol di-2-ethylhexoate.

Actually, the dioctyl phthalate and the triethylene glycol di-2-ethylhexoate are similar substances, both of which are double-terminated octyl ester structures (or analogues), and the difference is that a main chain of the triethylene glycol di-2-ethylhexoate is of a tripolyethylene glycol structure (triethylene glycol structure) with better hydrophilicity. The inventor considers that the reason is probably that the triethylene glycol main chain has better hydrophilicity than a phthalate main structure in combination with the fact that 3G8 is more suitable as the PVB plasticizer than DOP in the prior art. Based on the above new findings, the ideal PVB plasticizer should have certain polarity and should not be completely hydrophobic like DOP.

With reference to the structural analysis of molecules of the triethylene glycol di-2-ethylhexoate by the inventor, hydrophobic modification can be carried out at one or both terminals of polar molecules; these polar molecules may be: polyether/polyether polyol or polyester/polyester polyol; hydrophilic modification can also be carried out at one or both terminals of low-polarity molecules; and these low-polarity molecules may be polyester/polyester polyol, fatty alcohol, polyethylene wax, etc. In the prior art, a nonionic surfactant belongs to low-polarity molecules hydrophilically modified at one terminal, or polar molecules oleophylically modified at one terminal.

Therefore, the inventor selected a series of substances for studying the tensile strength and elongation at break of PVB. Finally, the PVB plasticizer superior to 3G8, namely, polyoxyethylene ether with low polar groups, was selected.

As a further improvement of the above technical solution, R1 is an alkyl group having 6 to 12 carbon atoms; and R2 is an aliphatic hydrocarbon group with an even number of carbon atoms on a carbon chain.

As a preference of the above technical solution, the amphiphilic oligomer plasticizer has an HLB value ranging from 2 to 20.

As a preference of the above technical solution, the amphiphilic oligomer plasticizer has an HLB value ranging from 5 to 20.

As a preference of the above technical solution, the amphiphilic oligomer plasticizer has an HLB value ranging from 9 to 18.

As a preference of the above technical solution, 3-80 parts by weight of the amphiphilic oligomer plasticizer are added based on 100 parts by weight of a PVB polymer.

As a preference of the above technical solution, 20-50 parts by weight of the amphiphilic oligomer plasticizer are added based on 100 parts by weight of a PVB polymer.

As a preference of the above technical solution, the amphiphilic oligomer plasticizer is fatty alcohol polyoxyethylene ether or alkylphenol ethoxylates.

As a preference of the above technical solution, the amphiphilic oligomer plasticizer is selected from a group consisting of one or more of polyoxyethylene lauryl ether, polyoxyethylene cetyl ether, polyoxyethylene stearyl ether, polyoxyethylene oleyl ether, and polyoxyethylene eicosanol ether.

As a preference of the above technical solution, the amphiphilic oligomer plasticizer is polyoxyethylene octylphenol ether.

As a preference of the above technical solution, the polyoxyethylene octylphenol ether is Triton X-114 (Triton X-114).

As a preference of the above technical solution, the fatty alcohol polyoxyethylene ether is Brij O10 (Peregal 010).

In conclusion, the present disclosure has the following beneficial effects:
1. The elongation at break is a sign of softness of PVB. It is shown through experimental study that when the polyoxyethylene ether with non-polar groups is used as the PVB plasticizer, it has significant advantages compared to the triethylene glycol di-2-ethylhexoate 3G8, which is mainly reflected in significant increase in the elongation at break; and when about 29 wt % of plasticizer and 71 wt % of PVB are adopted, the elongation at break of a 3G8 group is 295.02%, the elongation at break of a Triton X-114 (CAS No. 9036-19-5) group is 371.37%, and the elongation at break of a Tergitol NP-9 (CAS No. 84133-50-6) group is 415.93%.
2. It is shown through further experimental study that when the alkylphenol ethoxylates are used as the PVB plasticizer, the tensile strength is also improved compared to the triethylene glycol di-2-ethylhexoate 3G8; and when about 29 wt % of plasticizer and 71 wt % of PVB are adopted, the tensile strength of the 3G8 group is 17.71 MPa, and the tensile strength of the Triton X-114 group is 22.74 MPa.
3. It is shown through further experimental study that when the fatty alcohol polyoxyethylene ether is used as the PVB plasticizer, it also has significant advantages in sound insulation compared to the triethylene glycol di-2-ethylhexoate 3G8.

### DETAILED DESCRIPTION OF THE EMBODIMENTS

The specific examples only explain the present disclosure instead of limiting it. Any modification made after those skilled in the art read the specification of the present disclosure falls within the scope of protection of the patent laws as long as it falls within the scope of the claims.

### Example 1

A polymer composition, includes 8.17 g of polyoxyethylene octylphenol ether Triton X-114 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Example 2

A polymer composition, includes 8.17 g of Tergitol NP-9 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 1

A polymer composition, includes 8.17 g of triethylene glycol di-2-ethylhexoate 3G8 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 2

A polymer composition, includes 8.17 g of polyethylene glycol PEG and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 3

A polymer composition, includes 8.17 g of dioctyl phthalate DOP and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 4

A polymer composition, includes 8.17 g of 1,4-dioctyl cyclohexane dicarboxylate CHC and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

Examples 1 and 2 and Comparative examples 1-4 were tested for relevant items. The test was carried out in accordance with the provisions of GB/T 1040.3-2006, type 5 samples were adopted, and sampling was carried out in a longitudinal direction of the samples. A test speed was 100±10 mm/min, and a gauge length was 25±0.25 mm. Results are shown in a table below.

| | | Tensile | Elongation |
|---|---|---|---|
| | Group | strength (Mpa) | at break (%) |
| Example 1 | Triton X-114 | 22.74 | 371.37 |
| Example 2 | Tergitol NP-9 | 15.76 | 415.93 |
| Comparative example 1 | 3G8 | 17.71 | 295.02 |
| Comparative example 2 | PEG | 8.58 | 415.46 |
| Comparative example 3 | DOP | 21.34 | 304.43 |
| Comparative example 4 | CHC | 26.88 | 272.17 |

It can be shown from the above table that Triton X-114 and Tergitol NP-9 groups have significant advantages in the elongation at break compared to existing plasticizers such as 3G8. Wherein, a PEG group has a higher elongation at break than a 3G8 group, but has too low tensile strength, which is only 8.58 Mpa, and PEG is a high-polarity polymer, which also limits its application in this aspect.

### Example 3

A polymer composition, includes 6.67 g of polyoxyethylene octylphenol ether Triton X-114 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Example 4

A polymer composition, includes 7.40 g of polyoxyethylene octylphenol ether Triton X-114 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Example 5

A polymer composition, includes 8.17 g of polyoxyethylene octylphenol ether Triton X-114 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Example 6

A polymer composition, includes 8.99 g of polyoxyethylene octylphenol ether Triton X-114 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 2 mm.

### Example 7

A polymer composition, includes 9.85 g of polyoxyethylene octylphenol ether Triton X-114 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 5

A polymer composition, includes 6.67 g of triethylene glycol di-2-ethylhexoate 3G8 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 6

A polymer composition, includes 7.40 g of triethylene glycol di-2-ethylhexoate 3G8 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 7

A polymer composition, includes 8.17 g of triethylene glycol di-2-ethylhexoate 3G8 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 8

A polymer composition, includes 8.99 g of triethylene glycol di-2-ethylhexoate 3G8 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

### Comparative Example 9

A polymer composition, includes 9.85 g of triethylene glycol di-2-ethylhexoate 3G8 and 20 g of polyvinyl butyral resin PVB_18K18. The PVB_18K18 refers to PVB molecular degree of polymerization being about 1800 and —OH content being about 18 wt %.

The polymer composition was heated to 90° C., stirred under vacuum until it was completely compatible, and extruded through a casting process, to prepare a PVB film with a thickness of 0.8 mm.

Examples 3-7 and Comparative examples 5-9 were tested for relevant items. The test was carried out in accordance with the provisions of GB/T 1040.3-2006, type 5 samples were adopted, and sampling was carried out in a longitudinal direction of the samples. A test speed was 100±10 mm/min, and a gauge length was 25±0.25 mm.

Test results are shown in a table below.

| | | Tensile | Elongation |
|---|---|---|---|
| | Group | strength (Mpa) | at break (%) |
| Example 3 | TX114-25.0 wt % | 31.46 | 319.69 |
| Comparative | 3G8-25.0 wt % | 24.02 | 266 |
| example 5 | | | |
| Example 4 | TX114-27.0 wt % | 24.65 | 340.74 |
| Comparative | 3G8-27.0 wt % | 23.85 | 277.32 |
| example 6 | | | |
| Example 5 | TX114-29.0 wt % | 22.74 | 371.37 |
| Comparative | 3G8-29.0 wt % | 17.71 | 295.02 |
| example 7 | | | |
| Example 6 | TX114-31.0 wt % | 18.73 | 395.82 |
| Comparative | 3G8-31.0 wt % | 15.39 | 296.62 |
| example 8 | | | |
| Example 7 | TX114-33.0 wt % | 12.29 | 425.73 |
| Comparative | 3G8-33.0 wt % | 15.22 | 304.34 |
| example 9 | | | |

It can be shown from the above table that when used as the PVB plasticizer relative to 3G8, Triton X-114 has significant advantages in the elongation break and tensile strength in terms of mechanical performance.

### Example 8

A polymer composition, includes 9.85 g of polyoxyethylene octylphenol ether Triton X-114 and 20 g of polyvinyl butyral resin PVB_18K26. The PVB_18K26 refers to PVB molecular degree of polymerization being about 1800 and —OH content being about 26 wt %.

The polymer composition was heated to 90° C., stirred under vacuum until it was completely compatible, and extruded through a casting process, to prepare a PVB film with a thickness of 0.8 mm.

### Comparative Example 10

A polymer composition, includes 9.85 g of triethylene glycol di-2-ethylhexoate 3G8 and 20 g of polyvinyl butyral resin PVB_18K26. The PVB_18K26 refers to PVB molecular degree of polymerization being about 1800 and —OH content being about 26 wt %.

The polymer composition was heated to 90° C., but cannot be completely compatible after being stirred under vacuum.

### Comparative Example 11

A polymer composition, includes 8.57 g of triethylene glycol di-2-ethylhexoate 3G8 and 20 g of polyvinyl butyral resin PVB_18K26. The PVB_18K26 refers to PVB molecular degree of polymerization being about 1800 and —OH content being about 26 wt %.

The polymer composition was heated to 90° C., but cannot be completely compatible after being stirred under vacuum.

### Comparative Example 12

A polymer composition, includes 7.40 g of triethylene glycol di-2-ethylhexoate 3G8 and 20 g of polyvinyl butyral resin PVB_18K26. The PVB_18K26 refers to PVB molecular degree of polymerization being about 1800 and —OH content being about 26 wt %.

The polymer composition was heated to 90° C., but cannot be completely compatible after being stirred under vacuum.

Example 8 and Comparative example 10 were tested for relevant items. The test was carried out in accordance with the provisions of GB/T 1040.3-2006, type 5 samples were adopted, and sampling was carried out in a longitudinal direction of the samples. A test speed was 100±10 mm/min, and a gauge length was 25±0.25 mm.

Test results are shown in a table below.

| | | Tensile | Elongation |
|---|---|---|---|
| | Group | strength (Mpa) | at break (%) |
| Example 8 | TX114-33.0 wt % | 13.85 | 487.32 |
| Comparative | 3G8-33.0 wt % | — | — |
| example 10 | | | |
| Comparative | 3G8-30.0 wt % | — | — |
| example 11 | | | |
| Comparative | 3G8-27.0 wt % | — | — |
| example 12 | | | |

It can be shown from the above table that when the —OH content of PVB is increased to 26 wt %, there is a significant incompatibility between 3G8 and PVB under a high use amount. Triton X-114 is compatible with PVB regardless of molecular weight and —OH content, indicating that 3G8 is not suitable for all types of PVB, which also shows that Triton X-114 is more suitable for the PVB plasticizer than 3G8.

### Example 9

A polymer composition is prepared into a film through ABA three-layer co-extrusion, wherein a thickness of a layer A is about 350 m, and a thickness of a middle layer B is about 100 m.

Furthermore, a material of the outer layer A is prepared from 27.5% of plasticizer triethylene glycol di-2-ethylhexoate 3G8 and 72.5% of PVB_18K18 resin powder, and the PVB_18K18 refers to PVB molecular degree of polymerization being about 1800 and —OH content being about 18 wt %.

Furthermore, a material of the inner layer B is prepared from 45% of fatty alcohol polyoxyethylene ether Brij 010 (CAS No. 9004-98-2) and 55% of polyvinyl butyral resin PVB_18K18.

A PVB film with a thickness of 0.8 mm is prepared through three-layer co-extrusion and denoted as SP10.

### Example 10

A polymer composition is prepared into a film through ABA three-layer co-extrusion, wherein a thickness of a layer A is about 350 m, and a thickness of a middle layer B is about 100 m.

Furthermore, a material of the outer layer A is prepared from 27.5% of plasticizer triethylene glycol di-2-ethylhexoate 3G8 and 72.5% of PVB_18K18 resin powder, and the PVB_18K18 refers to PVB molecular degree of polymerization being about 1800 and —OH content being about 18 wt %.

Furthermore, a material of the inner layer B is prepared from 50% of fatty alcohol polyoxyethylene ether Brij 010 (CAS No. 9004-98-2) and 50% of polyvinyl butyral resin PVB_18K18.

A PVB film with a thickness of 0.8 mm is prepared through three-layer co-extrusion and denoted as SP 12 0.8.

### Example 11

A polymer composition is prepared into a film through ABA three-layer co-extrusion, wherein a thickness of a layer A is about 350 m, and a thickness of a middle layer B is about 100 m.

Furthermore, a material of the outer layer A is prepared from 27.5% of plasticizer triethylene glycol di-2-ethylhexoate 3G8 and 72.5% of PVB_18K18 resin powder, and the PVB_18K18 refers to PVB molecular degree of polymerization being about 1800 and —OH content being about 18 wt %.

Furthermore, a material of the inner layer B is prepared from 65% of fatty alcohol polyoxyethylene ether Brij 010 (CAS No. 9004-98-2) and 35% of polyvinyl butyral resin PVB_18K18.

A PVB film with a thickness of 0.8 mm is prepared through three-layer co-extrusion and denoted as SP 15 0.8.

### Example 12

A polymer composition is prepared into a film through ABA three-layer co-extrusion, wherein a thickness of a layer A is about 350 m, and a thickness of a middle layer B is about 100 m.

Furthermore, a material of the outer layer A is prepared from 27.5% of plasticizer triethylene glycol di-2-ethylhexoate 3G8 and 72.5% of PVB_18K18 resin powder, and the PVB_18K18 refers to PVB molecular degree of polymerization being about 1800 and —OH content being about 18 wt %.

Furthermore, a material of the inner layer B is prepared from 70% of fatty alcohol polyoxyethylene ether Brij C10 (CAS No. 9004-95-9) and 30% of polyvinyl butyral resin PVB_18K18.

A PVB film with a thickness of 0.8 mm is prepared through three-layer co-extrusion and denoted as SP18.

### Example 13

The example is the same as Example 10 except that a thickness of a PVB film is 0.3 mm, wherein a thickness of a material of an outer layer A is 131.25 m, a thickness of a material of an inner layer B is about 37.5 m, and the PVB film is denoted as SP12 0.3.

### Example 14

The example is the same as Example 11 except that a thickness of a PVB film is 0.3 mm, wherein a thickness of a material of an outer layer A is 131.25 am, a thickness of a material of an inner layer B is about 37.5 m, and the PVB film is denoted as SP15 0.3.

### Comparative Example 13

A polymer composition is prepared into a film through ABA three-layer co-extrusion, wherein a thickness of a layer A is about 350 m, and a thickness of a middle layer B is about 100 m.

Furthermore, a material of the outer layer A is prepared from 27.5% of plasticizer triethylene glycol di-2-ethylhexoate 3G8 and 72.5% of PVB_18K18 resin powder, and the PVB_18K18 refers to PVB molecular degree of polymerization being about 1800 and —OH content being about 18 wt %.

Furthermore, a material of the inner layer B is prepared from 60% of triethylene glycol di-2-ethylhexoate 3G8 and 40% of polyvinyl butyral resin PVB_18K18.

A PVB film with a thickness of 0.8 mm was prepared through three-layer co-extrusion and denoted as SP22.

Examples 9-14 and Comparative example 13 were tested for sound insulation, and the test was carried out in accordance with the provisions of GB/Z 27764-2011.

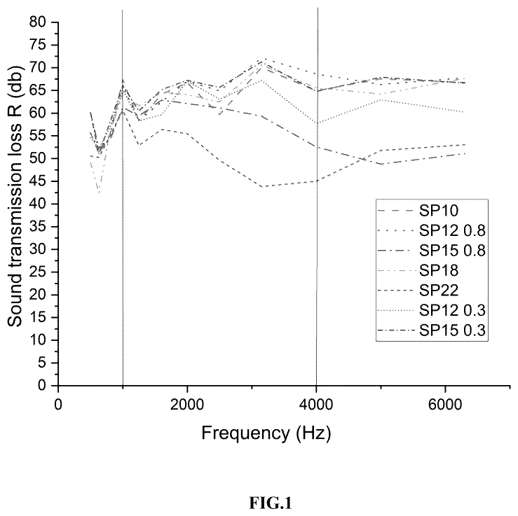

Test results are shown in FIG. 1.

It can be shown from FIG. 1 that SP22 has the minimum sound transmission loss based on a curve corresponding to Comparative example 13; even SP12 03 and SP15 0.3 groups with obviously lower overall thicknesses also have the higher sound transmission loss; and it can be shown that the fatty alcohol polyoxyethylene ether has significant advantages in terms of sound insulation when used as the PVB plasticizer compared to 3G8. In addition, it can be shown that when a thickness of a middle layer reaches 100 m, and the overall thickness reaches 0.8 mm, a formula of a material of the layer B has little impact; and when the thickness of the middle layer is only 37.5 m, and the overall thickness is only 0.3 mm, the formula of the material of the layer B has great impact, and the SP12 0.3 group has the sound insulation effect better than that of the SP 15 0.3 group. It can be shown from the above experiment that 1) the fatty alcohol polyoxyethylene ether has significant advantages in terms of sound insulation when used as the PVB plasticizer compared to 3G8; 2) when the middle layer is thick, the use amount of the PVB plasticizer, namely the fatty alcohol polyoxyethylene ether has little impact on the sound insulation effect; and when the middle layer is thin, the above impact is great, and when the use amount is about 50%, the effect is better than that achieved when the use amount is about 65%. Furthermore, it can be inferred that although the thickness has a certain impact, the effect is the best when the use amount of the fatty alcohol polyoxyethylene ether is about 50%.

What is claimed is:

1. A polymer composition, comprising polyvinyl butyral (PVB) resin and an amphiphilic oligomer plasticizer, wherein the amphiphilic oligomer plasticizer has a structure as shown in a formula 1a or 1b; 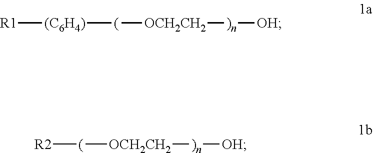
wherein, n is an integer ranging from 2 to 30; R1 is a saturated or unsaturated aliphatic hydrocarbon group having 6 to 16 carbon atoms in a linear carbon chain or branched chain form; and R2 is a saturated or unsaturated aliphatic hydrocarbon group having 12 to 20 carbon atoms in a linear carbon chain form.

2. The polymer composition according to claim 1, wherein R1 is an alkyl group having 6 to 12 carbon atoms; and R2 is an aliphatic hydrocarbon group with an even number of carbon atoms on a carbon chain.

3. The polymer composition according to claim 1, wherein the amphiphilic oligomer plasticizer has an HLB value ranging from 2 to 20.

4. The polymer composition according to claim 1, wherein the amphiphilic oligomer plasticizer has an HLB value ranging from 5 to 20.

5. The polymer composition according to claim 1, wherein the amphiphilic oligomer plasticizer has an HLB value ranging from 9 to 18.

6. The polymer composition according to claim 1, wherein 3-80 parts by weight of the amphiphilic oligomer plasticizer are added based on 100 parts by weight of a PVB polymer.

7. The polymer composition according to claim 1, wherein 20-50 parts by weight of the amphiphilic oligomer plasticizer are added based on 100 parts by weight of a PVB polymer.

8. The polymer composition according to claim 1, wherein the amphiphilic oligomer plasticizer is fatty alcohol polyoxyethylene ether or alkylphenol ethoxylates.

9. The polymer composition according to claim 8, wherein the amphiphilic oligomer plasticizer is selected from a group consisting of one or more of polyoxyethylene lauryl ether, polyoxyethylene cetyl ether, polyoxyethylene stearyl ether, polyoxyethylene oleyl ether, and polyoxyethylene eicosanol ether.

10. The polymer composition according to claim 1, wherein the amphiphilic oligomer plasticizer is polyoxyethylene octaphenyl ether.
